(19) United States
(12) Patent Application Publication
(10) Pub. No.: US 2018/0004364 A1
(43) Pub. Date: Jan. 4, 2018

(54) DIGITAL USER INTERFACE WITH ITEM SELECTION

(71) Applicant: eBay Inc., San Jose, CA (US)

(72) Inventor: Junlong Wu, Shanghai (CN)

(21) Appl. No.: 15/200,936

(22) Filed: Jul. 1, 2016

(51) Int. Cl. G06F 3/0482; G06F 3/0481; G06F 3/0484; G06F 17/30

(52) U.S. Cl. CPC G06F 3/0482; G06F 17/30507; G06F 3/0481; G06F 3/04847

(57) ABSTRACT

A computer-implemented method of item selection that includes presenting multiple first items that are user selectable in a user interface that each include at least one data field. The method further includes obtaining a user selection of at least one of the first items and generating a rule using a data value from the at least one data field of the user selected item. The method may further include presenting the rule in the user interface. The rule may be user selectable such that deselection of the rule prevents use of the rules in an automatic selection of items among the first items. The method may further include determining an item selection set using the rule. The item selection set may include multiple second items that are a subset of the first items. The second items may include the user selected item and other items of the first items.

### FIELD

The embodiments discussed herein are related to digital user interfaces with item selection.

### BACKGROUND

As an ever-increasing amount of information is being made available electronically, typically over networks such as the Internet, it is increasingly difficult to locate items or other content that may be of interest to a user. Once items are located, a similar operation may be performed on all of the located items. If all of the relevant items are not located initially, however, multiple operations may have to be performed.

The subject matter claimed herein is not limited to embodiments that solve any disadvantages or that operate only in environments such as those described above. Rather, this background is only provided to illustrate one example technology area where some embodiments described herein may be practiced.

### BRIEF DESCRIPTION OF THE DRAWINGS

Example embodiments will be described and explained with additional specificity and detail through the use of the accompanying drawings in which:

FIG. 1 illustrates an example system configured to present a digital user interface;

FIGS. 2a-2d illustrate examples of different configurations of a digital user interface for constructing an item selection set;

FIGS. 3a and 3b are a flowchart of an example computer-implemented method of performing actions on an item selection set;

FIG. 4 is a flowchart of an example computer-implemented method of constructing rules;

FIGS. 5a and 5b are a flowchart of operations to perform actions on an item selection set;

FIG. 6 is a flowchart of an example computer-implemented method of item selection; and

FIG. 7 illustrates another example system configured to present a digital user interface.

### DESCRIPTION OF EMBODIMENTS

A variety of common tasks entail users selecting multiple items from a list to perform a common action on the multiple items. For example, in an on-line marketplace, a seller may have multiple items for sell. The seller may want to select certain items, e.g., listings, and perform a bulk action on the selected items. For example, the seller may want to delete, adjust a price, or deactivate selected items as a group. In these and other embodiments, the term bulk action may refer to a single received request for an action resulting in the action being applied to multiple different items without further received requests or guidance. As another example, a user in a folder or email application may select multiple items, such as files or emails, for copying, deleting, or renaming in a bulk action.

Current user interfaces may be cumbersome as each individual item may be selected individually. Other user interfaces may be configured to allow a search of the items using search terms. In these circumstances, the search terms may be provided by a user in string format or based on a user's selection of provided conditions for a search. However, providing adequate search strings or proper details in provided conditions may render search strings and selected conditions useless. Additionally, current user interfaces may not provide an interface to facilitate review of the selected items before a bulk action is performed on the items, which may result in items being incorrectly changed.

Some embodiments herein relate to computer-implemented methods, systems, or operations of automatically forming an item selection set and performing one or more actions on the item selection set. In some embodiments, an item selection set, which may include a set of items automatically selected, may be formed based on a user selection of one or more items from a list of items. For example, a selection of one or more items may be used to generate rules for the selection of the items in the item selection set. The rules may be presented to the user in the user interface. The user may select the desired rules and apply the rules to the lists of items to form the item selection set. After formation of the item selection set, the item selection set may be further modified by the user.

After forming an item selection set, a bulk action may be applied to each of the items in the item selection set. When a bulk action is requested, a secondary window may present the items from the item selection set for review before the bulk action is implemented. The secondary window may provide details about the items to allow for review of the items. Furthermore, the items may be removed from the item selection set in the secondary window. After confirmation of the items in the item selection set, the bulk action may be performed on the items.

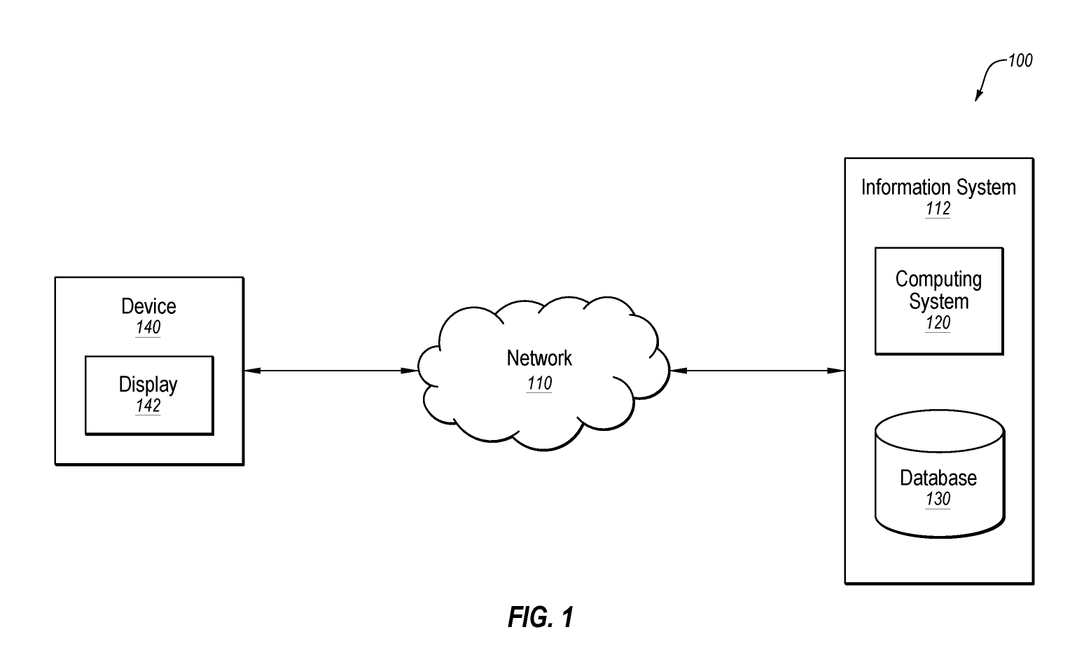

Turning to the figures, FIG. 1 illustrates an example system 100 configured to present a digital user interface. The system 100 may be arranged in accordance with at least one embodiment described in the present disclosure. The system 100 may include a network 110, an information system 112 that includes a computing system 120 and a database 130, and a device 140 that includes a display 142.

The network 110 may be configured to communicatively couple the information system 112 with the device 140. In some embodiments, the network 110 may be any network or configuration of networks configured to send and receive communications between devices. In some embodiments, the network 110 may include a conventional type network, a wired or wireless network, and may have numerous different configurations. Furthermore, the network 110 may include a local area network (LAN), a wide area network (WAN) (e.g., the Internet), or other interconnected data paths across which multiple devices and/or entities may communicate. In some embodiments, the network 110 may include a peer-to-peer network. The network 110 may also be coupled to or may include portions of a telecommunications network for sending data in a variety of different communication protocols. In some embodiments, the network 110 may include Bluetooth® communication networks or a cellular communications network for sending and receiving communications and/or data including via short message service (SMS), multimedia messaging service (MMS), hypertext transfer protocol (HTTP), direct data connection, wireless application protocol (WAP), email, etc. The network 110 may also include a mobile data network that may include third-generation (3G), fourth-generation (4G), long-term evolution (LTE), long-term evolution advanced (LTE-A), Voice-over-LTE (“VoLTE”) or any other mobile data network or combination of mobile data networks. Further, the network 110 may include one or more IEEE 802.11 wireless networks.

The device 140 may be any electronic device configured to provide a user with access to one or more systems, which may include one or more servers and databases, through a network. For example, the device 140 may include a desktop computer, a laptop computer, a smartphone, a mobile phone, a tablet computer, or any other processing device configured to access information over a network or internally. In some embodiments, the device 140 may be configured to receive digital data from the information system 112 and present the digital data to a user of the device 140. In these and other embodiments, the device 140 may present the information visually using a display 142. Alternately or additionally, the device may present the information in audio, by tactile response, or by some other method.

In some embodiments, the information system 112 may be any configuration of hardware, such as servers and databases that are networked together and configured to perform tasks. In some embodiments, the computing system 120 may be a single computing system that includes one or more processors and memory, such as a server or some other computing system, within the information system 112. Alternately or additionally, the computing system 120 may include multiple computing systems, such as multiple servers, that are networked together and configured to perform tasks within the information system 112. Alternately or additionally, the computing system 120 may include computing systems and/or computer-readable-instructions that are configured to be executed by the information system 112 to perform the operations described in this disclosure. The database 130 may be any configuration of digital data storage.

In some embodiments, the information system 112 may be configured to provide a user, through the device 140, with an ability to browse or search for information, services, or goods listed or included within the database 130 of the information system 112.

For example, the information system 112 may be configured as an online marketplace for a seller or sellers to sell goods to buyers. In these and other embodiments, the database 130 may include listings of goods or services to be sold that may be accessed by a user through a device, such as the device 140. For example, the database 130 may include information regarding listings for an individual seller, buyer, or groups of buyers and/or sellers. In some embodiments, the information system 112 may allow the device 140 to browse through the listings of goods and services or search for any information in the database 130.

Alternately or additionally, the information system 112 may be configured as another client or user centric type system. In these and other embodiments, the database 130 may include other information that may be accessed by the device 140. For example, the information may be business information related to files maintained by a business, health care information, financial information, among other types of information.

In some embodiments, the computing system 120 may be configured to handle digital requests for presentation of digital data from the database 130. For example, a user may be accessing the information system 112 via the device 140 and the network 110. Based on the interaction with the information system 112, the device 140 may send a digital request for information. For example, if the information system 112 is an online marketplace, the device 140 may request information regarding items to be sold. As another example, if the information system 112 is a business database or document database, the device 140 may request all information/documents pertaining to a certain business matter.

In general, the computing system 120 may be configured to handle the digital requests for information. In some embodiments, the digital requests may include a request for information with multiple data entries in the database 130. In these and other embodiments, the computing system 120 may search the database 130 to determine the data entries in the database 130 that may fulfill the request. In some embodiments, some or all of the data entries may each include an item that includes one or more data fields. The computing system 120 may send all or some of the data entries in the database 130 to the device 140. In some embodiments, the computing system 120 may provide additional data, such as computer-readable instructions, regarding selection of the data entries and actions that may be performed on the data entries.

The device 140 may be configured to present the data entries by way of the display 142. In some embodiments, the device 140 may present the items from each of the data entries. In these and other embodiments, the device 140 may present one or more of the fields of each of the items. The device 140 may also be configured to present a user interface to allow a user of the device 140 to select one or more of the items. Based on the selection of one or more of the items, the device 140, using the additional data, may determine one or more rules for automatic selection of additional items. For example, the device 140 may analyze data values in one or more data fields of the items selected. Using the data values, the device 140 may determine the rules.

In some embodiments, the device 140 may be configured to present the rules to a user, for example, through the display 142. In some embodiments, the rules may also be selectable. In these and other embodiments, a user may determine which of the rules to apply to the remaining items to allow the device 140 to determine an item selection set of items that adhere to the selected rules. For example, in some embodiments, the rules may be presented initially as all selected. In these and other embodiments, the user may deselect the undesired rules. Alternatively, the rules may be presented initially as all unselected. In these and other embodiments, the user may select the desired rules.

Alternatively or additionally, the rules may be editable. In these and other embodiments, a user may edit the rules. For example, a user may edit a value, a comparison factor, a conditional, or other aspects of the rules. In these and other embodiments, the edited rules may be used by the device 140 to determine an item selection set.

In some embodiments, the device 140 may be configured to determine an item selection set using the rules in response to a request from a user. Alternatively or additionally, the device 140 may determine an item selection set after a determination of the rules and the passage of an interval. In some embodiments, an interval may be a set or random period of time. Alternatively or additionally, an interval may be based on a change to one or more of the rules. In these and other embodiments, the device 140 may determine an item selection set after a change to one or more of the rules based on input from a user. For example, after selection or deselection of a rule, the device 140 may determine an item selection set. As another example, after a rule is edited, the device 140 may determine an item selection set. In these and other embodiments, the interval may be combination of a change to one or more rules, e.g., a selection, deselection, and/or edit, along with a passage of time after the change of the one or more rules.

In some embodiments, the device 140 may be configured to present the item selection set. For example, the device 140 may present the item selection set by presenting only the items in the item selection set. In these and other embodiments, the device 140 may change the presentation of the items in the current window to only present the items in the item selection set.

Alternatively or additionally, the device 140 may present the item selection set by distinguishing the items in the item selection set from items not in the item selection set. For example, the device 140 may highlight, change the text color, text font, text size, or otherwise manipulate the items in the item selection set to differentiate the items in the item selection set from items not in the item selection set.

Alternatively or additionally, the items may each include a data field related to the selection of the items, such as a selection data field. In these and other embodiments, the device 140 may alter or change the selection data field to indicate that an item is in the item selection set. Alternatively or additionally, the device 140 may alter or change the selection data field of items not in an item selection set to distinguish the items in the item selection set.

In some embodiments, the device 140 may be configured to display one or more actions that may be performed on the items in the item selection set. The actions may be performed by the computing system 120 to change the underlying data items in the database 130. For example, the actions may include deleting or changing one or more aspects of the items. The aspects of the items that may be changed may include changing of data values in one or more of the data fields in the items. For example, if the items are listings in an on-line marketplace, actions may include delisting, adjusting price, adjusting item description, and/or adjusting other objects or data fields of listings on an on-line marketplace. As another example, the items may be files in a database. In these and other embodiments, the items may be deleted, moved, renamed, or other objects or data fields of the files may be adjusted.

In some embodiments, after user selection of one or more actions to perform on the item selection set, the device 140 may be configured to present the item selection set to the user. In these and other embodiments, the user may be able to confirm that the items in the item selection set are the items to which the action should be applied. In some embodiments, the item selection set may be presented in a window separate from presentation of the items not in the item selection set.

In some embodiments, all or some of the data fields of the items in the item selection set may be presented. In these and other embodiments, when less than all of the data fields are presented, the data fields selected may be data fields associated with the rules that are used to create the item selection set. For example, an item may include a data field for price and a rule may pertain to items within a price range. The item may also include data fields associated with a date and a location. In these and other embodiments, the data field associated with the rule may be the price data field and a price for each of the items in the item selection set may be presented while the date and the location for each of the items in the item selection set may not be presented.

In some embodiments, the items in the item selection set presented for confirmation may be confirmed as a member of the item selection set. In these and other embodiments, the device 140 may present all of the items as members of the item selection set and the user may deselect the items that may not be part of the item selection set. Alternatively or additionally, the device 140 may present all of the items as not being part of the item selection set. For example, each of the items in the items selection set may be deselected. In these and other embodiments, a user may select or confirm the items that may be part of the item selection set. Alternately or additionally, the items in the selection set that are selected by the user may be indicated as confirmed and items automatically selected by the device 140 based on the rules may be indicated as not confirmed.

In some embodiments, in response to the confirmation of the item selection set, the device 140 may provide an indication of the item selection set and the action to be performed to the computing system 120. In these and other embodiments, the computing system 120 may be configured to perform the action on the item selection set. For example, the computing system 120 may alter the data entries in the database 130 that include the items in the item selection set. After performing the action, the computing system 120 may provide the device 140 with data entries that correspond with the initial request from the device 140. In some embodiments, the data entries may include all of the data entries previously provided, but with some or all of the data entries including different data values in some of the data fields. Alternatively or additionally, some or none of the data entries provided by the computing system 120 after performing the action may be the same as the data entries previously provided. The items in the data entries provided to the device 140 may be presented in the user interface on the display 142.

Modifications, additions, or omissions may be made to the system 100 without departing from the scope of the present disclosure. For example, the information system 112 may include additional components and/or networks than those illustrated in or described with respect to FIG. 1. For example, the information system 112 may include additional databases, servers, and other computing systems configured to perform other tasks for the information system 112.

Alternately or additionally, the computing system 120 as described may be located outside of the information system 112. In these and other embodiments, the computing system 120 may be coupled to the network 110 and may access the database 130 over the network 110. Alternately or additionally, the database 130 may be separate from the information system 112. In these and other embodiments, the database 130 may be communicatively coupled to the network 110.

Alternately or additionally, the computing system 120 and/or database 130 may be part of the device 140. In these and other embodiments, the device 140 may not communicate over the network 110 to change the items in the item selection set. Rather, the device 140 by way of the computing system 120 may adjust the database 130 and may present the update items on the display 142 to a user.

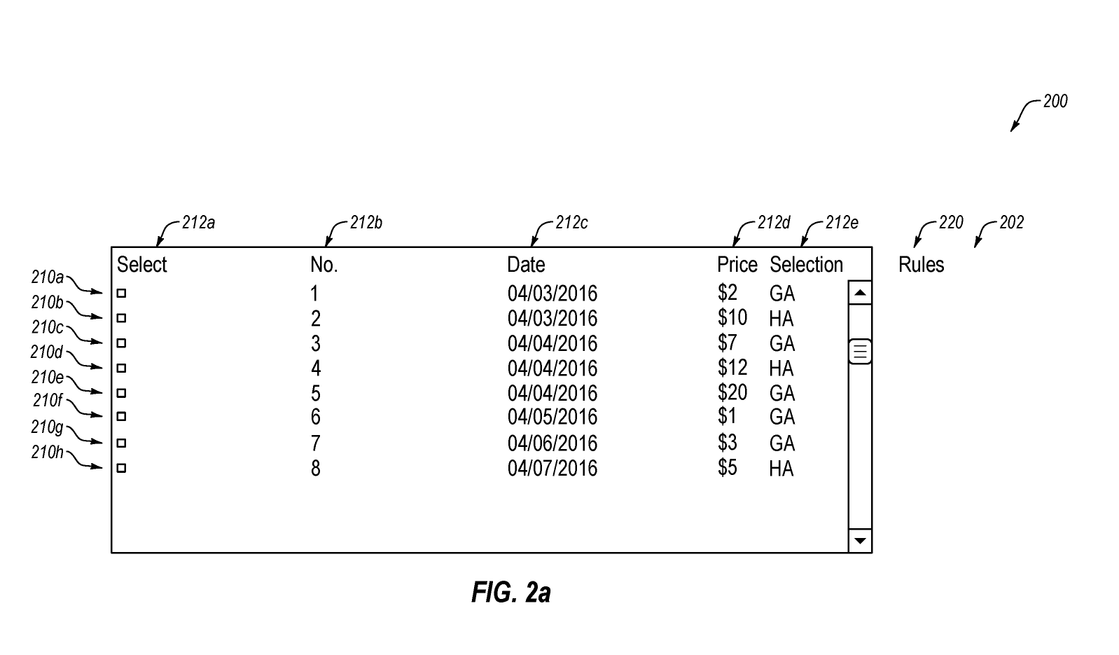

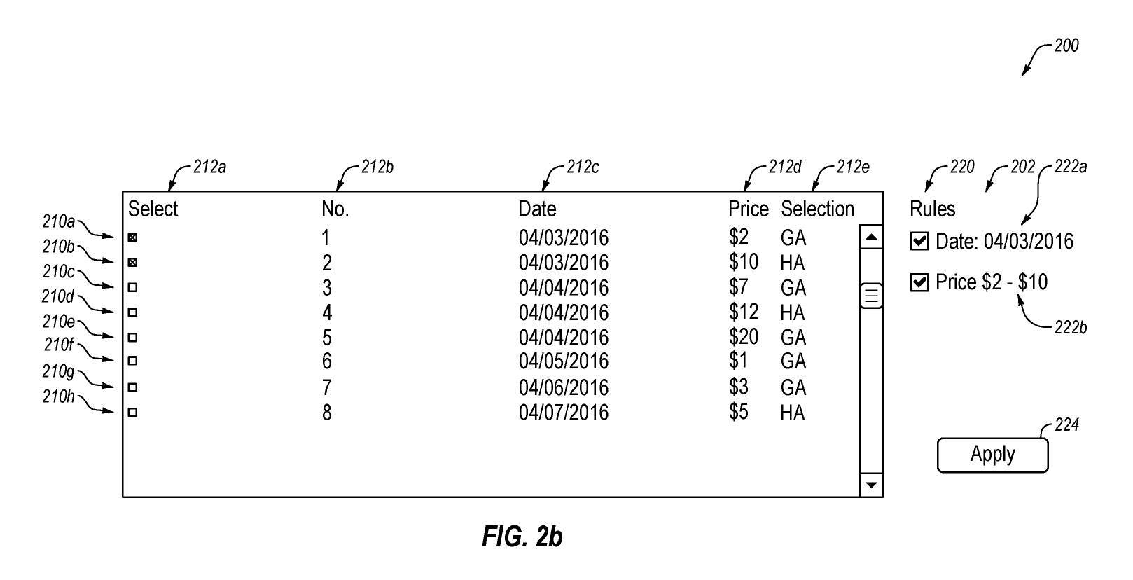

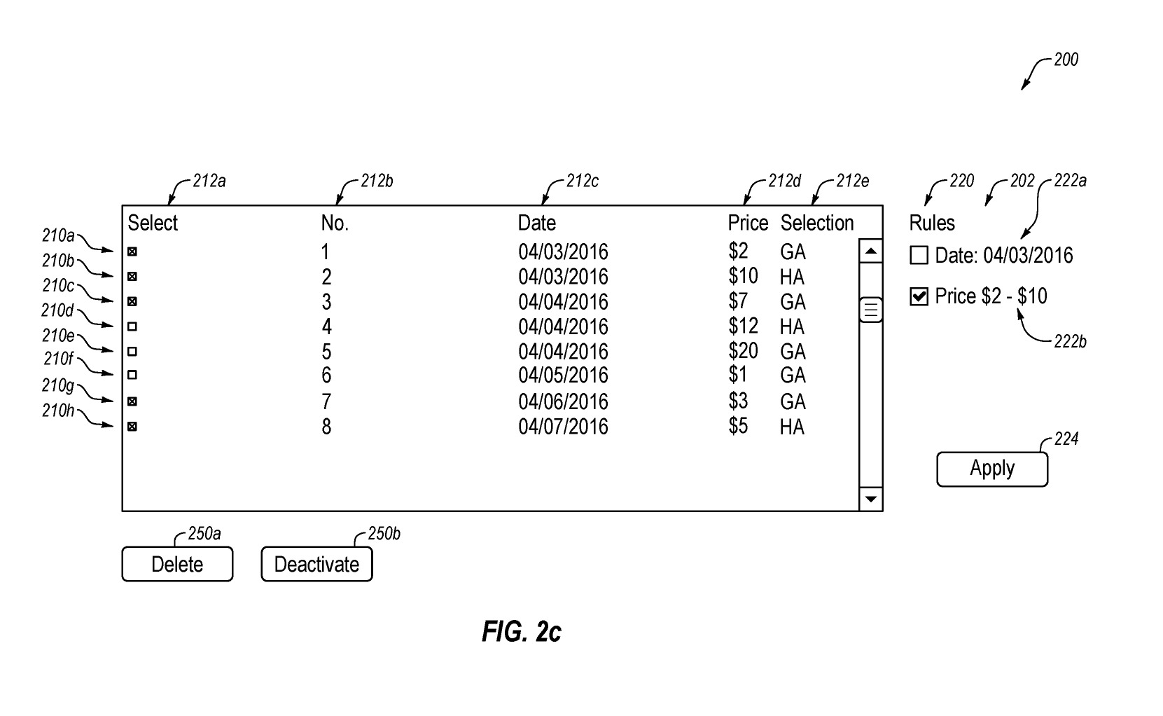

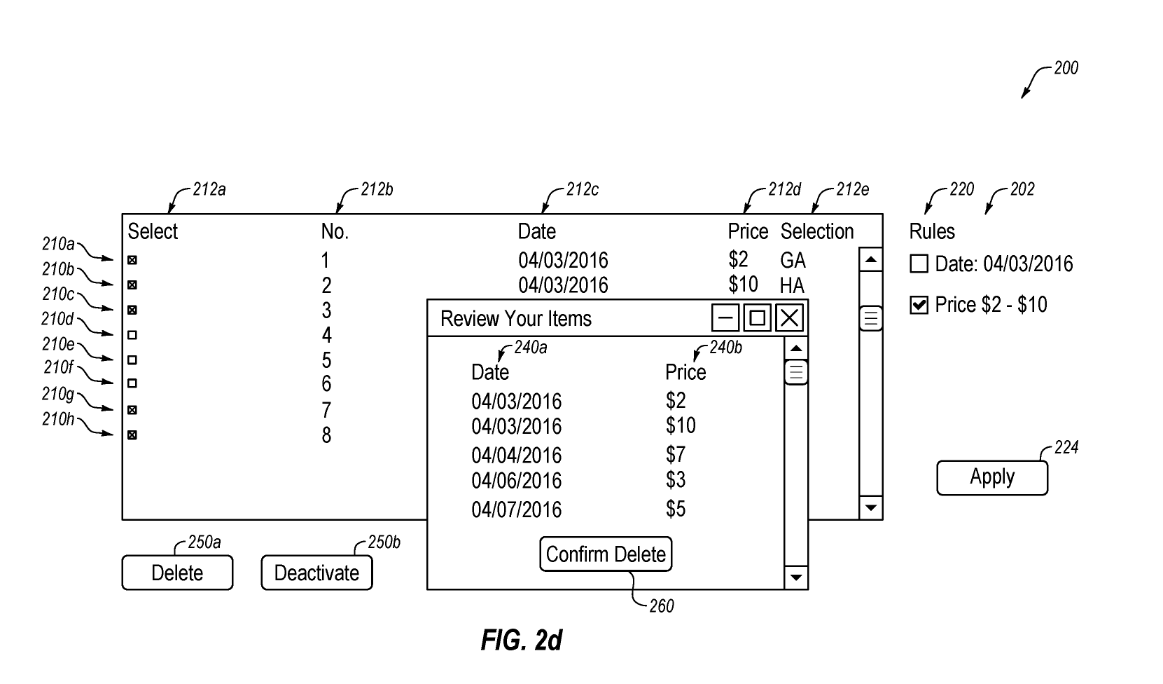

FIGS. 2a-2d illustrates examples of different configurations of a digital user interface for constructing an item selection set. The different configurations of the digital user interface 200 may be arranged in accordance with at least one embodiment described in the present disclosure.

As illustrated in FIGS. 2a-2d, the digital user interface 200 may be implemented by a web browser or an application that is presenting a webpage based on instructions. For example, the web browser may receive instructions and items. Using the instructions, the web browser may present the user interface and the items in the user interface. In some embodiments, the instructions may include a combination of hypertext markup language (HTML) and JavaScript based instructions. In these and other embodiments, the web browser may receive all of the instructions to present the user interface as illustrated in FIGS. 2a-2d before presentation of the user interface. Alternatively or additionally, the web browser may communicate with another system to receive further instructions based on user interaction with the user interface to present different aspects of the user interface as described in FIGS. 2a-2d.

FIG. 2a may illustrate the digital user interface 200 that may be provided by a device for presentation to a user in response to the reception of a request for data. The digital user interface 200 may include a first window 202. The first window 202 may present a first item 210a, a second item 210b, a third item 210c, a fourth item 210d, a fifth item 210e, a sixth item 210f, a seventh item 210g, and an eighth item 210h, referred to collectively as the items 210. Each of the items 210 may include a first data field 212a, a second data field 212b, a third data field 212c, a fourth data field 212d, and a fifth data field 212e, referred to collectively as the data fields 212. The first window 202 may further include a rules region 220.

As illustrated, each of the items 210 may include a data value in the data fields 212. For example, the first data field 212a may indicate if an item 210 is selected. As illustrated in FIG. 2a, none of the items 210 are selected. The second data field 212b may include data values that represent a numbering for the items 210 used by a database that may store the items 210 or some other type of system identifier for the items 210.

The third data field 212c may include data values that represent a date associated with the items 210. The fourth data field 212d may include data values that represent a price associated with the items 210. The fifth data field 212e may include data values that represent information associated with the items 210. In some embodiments, the items 210 may be tickets for a venue. In these and other embodiments, the fifth data field 212e may be a section in the venue for seats associated with the tickets.

In some embodiments, the first data field 212a may be interactive. In these and other embodiments, a user may interact with the first data field 212a to select one or more of the items 210. For example, FIG. 2b illustrates the selection of the first item 210a and the second item 210b. Based on the selection, a first rule 222a and a second rule 222b, collectively referred to as the rules 222, are presented in the rules region 220.

The rules 222 may be determined based on the data values of the data fields 212 of the items 210 selected. The data fields selected for construction of the rules may be selected by a user and/or assigned by the instructions that implement the user interface. For example, the first rule 222a is based on the third data field 212c. Thus, the first rule 222a is associated with a date of the items 210 as the third data field 212c presents data associated with the items 210. As another example, the second rule 222b is based on the fourth data field 212d. Thus, the second rule 222b is associated with a price of the items 210 as the fourth data field 212d presents prices associated with the items 210.

The values for the rules 222 may be determined based on the data values of the selected items 210. For example, when all of the selected items have a first value for a first data field, the rule may be to select items with the first value in the first data field. For example, the first item 210a and the second item 210b may be selected and both include the date of Apr. 3, 2016 in the third data field 212c. Thus, the first rule 222a for the third data field 212c may be to select items 210 with the date of Apr. 3, 2016 in the third data field 212c.

As another example, a rule may be constructed based on the values of the selected items resulting in a range of values. For example, a first value may be X, a second value may be Y, and a third value may be Z, where X<Y<Z. In these and other embodiments, the rule may be to select items 210 with a value between X and Z. For example, the first item 210a and the second item 210b are selected and the first item 210a has a value of 2 in the fourth data field 212d. The second item 210b has a value of 10 in the fourth data field 212d. Thus, the second rule 222b for the fourth data field 212d is to select items with a value between 2 and 10 in the fourth data field 212d.

As another example, a rule may be constructed based on the values of the selected items resulting in a set of values. For example, a first value may be X, a second value may be Y, and third value may be Z, to form a set of X, Y, and Z In these and other embodiments, the rule may be to select items 210 with a value that matches one of the values in the set.

The rules 222 are presented as selected. A rule application selector 224 is also presented in the rules region 220. The rule application selector 224 when selected may apply the selected rules 222 to the items 210 to select one or more of the rules. In these and other embodiments, the rules 222 may be unselected such that the rules 222 are not applied to automatically select items 210 to produce an item selection set when the rule application selector 224 is selected.

FIG. 2c illustrates the deselection of the first rule 222a and the application of the second rule 222b to the items 210 to automatically select the third item 210c, the seventh item 210g, and the eighth item 210h. As illustrated, the third item 210c, the seventh item 210g, and the eighth item 210h may be automatically selected based on the third item 210c, the seventh item 210g, and the eighth item 210h including a value in the fourth data field 212d that adhered to the second rule 222b. The selected items 210 may form an item selection set.

The fourth item 210d, the fifth item 210e, and the sixth item 210f were not selected based on the fourth item 210d, the fifth item 210e, and the sixth item 210f not including a value in the fourth data field 212d that adhered to the second rule 222b.

FIG. 2c further illustrates a first action button 250a and a second action button 250b, referred to collectively as the action buttons 250, that may be selected to have an action applied to the item selection set. The first action button 250a may be associated with an action to delete the items 210 in the item selection set. The second action button 250b may be associated with an action to deactivate the items 210 in the item selection set. To deactivate the items 210 may include an ability to cause the items 210 to not be presented for sale but to be maintained in a database.

FIG. 2d illustrates the selection of the first action button 250a. After selection of the first action button 250a, a second window 204 may be presented by the digital user interface 200. The second window 204 may present the items 210 from the item selection set. In these and other embodiments, the items 210 presented in the second window may include a first selected data field 240a and a second selected data field 240b, referred to collectively as the selected data fields 240. The first selected data field 240a may correspond to the third data field 212c. The second selected data field 240b may correspond to the fourth data field 212d. In some embodiments, the number of the selected data fields 240 may be fewer than the number of the data fields 212. In these and other embodiments, the selected data fields 240 may include the data fields 212 that are used to create the rules 222 used to obtain the item selection set.

In some embodiments, each of the items in the second window 204 may be selectable. Thus, one or more of the items may be unselected. In these and other embodiments, the selected action is not applied to the unselected items. The second window 204 may further include a confirm action button 260. The confirm action button 260 may be selected to apply the selected action to the selected items in the second window 204. In some embodiments, when there are more items in the items 210 from the item selection set than may be displayed by the second window 204, a scrolling bar or pagination of the items 210 from the item selection set may be provided to allow review of all of the items 210 from the item selection set.

Modifications, additions, or omissions may be made to the digital user interface 200 without departing from the scope of the present disclosure. For example, other arrangements and/or configurations of the digital user interface 200 may exist. For example, there may be more data fields 212. Alternatively or additionally, the rules region 220 positioning or interface may be different. In short, FIGS. 2a-2d are presented as an illustration of one example of the digital user interface 200, with other configurations and arrangements contemplated.

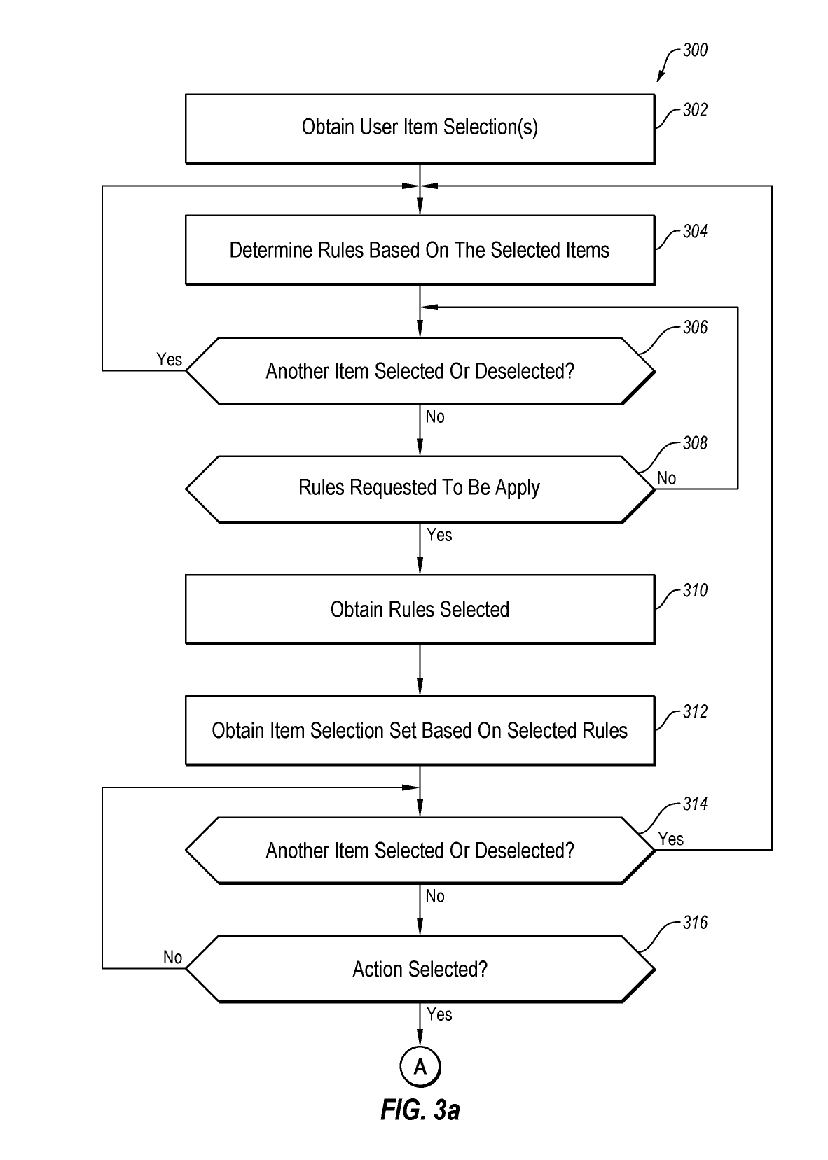

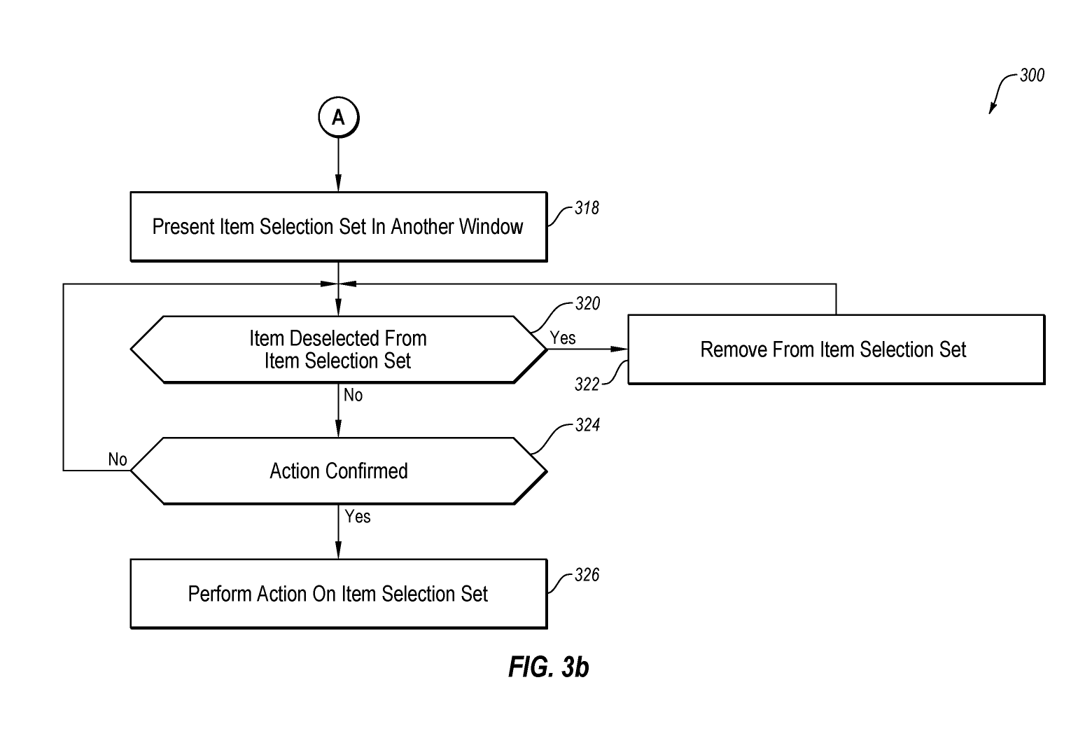

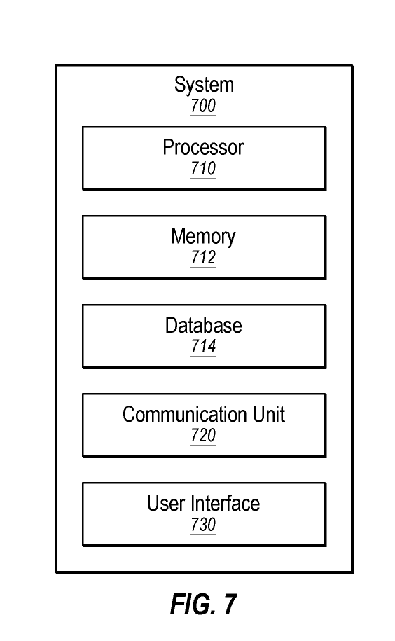

FIGS. 3a and 3b are a flowchart of an example computer-implemented method 300 of performing actions on an item selection set. The method 300 may be arranged in accordance with at least one embodiment described in the present disclosure. The method 300 may be implemented, in some embodiments, by a system, such as the system 100 and/or 700 of FIGS. 1 and 7, respectively. Although illustrated as discrete blocks, various blocks may be divided into additional blocks, combined into fewer blocks, or eliminated, depending on the desired implementation.

The method 300 may begin at block 302, where a user selection of items may be obtained. In these and other embodiments, the items may be presented in a user interface. The items may include multiple data fields with data values.

In block 304, rules may be determined based on the selected items. The rules may be determined based on the data values of one or more data fields of the selected items. In some embodiments, a rule may be generated for each of one or more designated data fields of the selected items.

In block 306, it may be determined if another item is selected or deselected. If no additional item is selected or deselected, the method 300 may proceed to block 308. If an additional item is selected or deselected, the method 300 may proceed to block 304.

In block 308, it may be determined if a request to apply the rules has been received. If a request has been received, the method 300 may proceed to block 310. If a request has not been received, the method 300 may proceed to block 306.

In block 310, the rules selected may be obtained. In these and other embodiments, when a rule is first determined it may be selected and presented. In these and other embodiments, the rule may be deselected after being presented. Alternatively or additionally, the rule may be edited. The rules currently selected and edited may be obtained.

In block 312, an item selection set may be obtained based on the selected rules. In these and other embodiments, the rules may be applied to the items in the user interface. In some embodiments, the rules may be applied by determining if a data value in a data field corresponding to a rule adheres to the rule. For example, if a rule includes a range of values for a data field, the data fields of the items may be searched for items with values in the data field that are within the range. The items that include a value within the range of the values of the rule may be incorporated into the item selection set. In these and other embodiments, database comparison algorithms, matching algorithms, sorting algorithms, or other algorithms may be used to determine the items with values that adhere to the rules for inclusion in the item selection set.

In block 314, it may be determined if another item is selected or deselected. When another item is selected or deselected, the method 300 may proceed to block 304. When another item is selected or deselected, the rules may be adjusted based on the selection or deselection. For example, additional rules may be added or rules may be removed. Alternatively or additionally, the conditions of the rules may be changed. For example, if a user deselected an item with a value of X where a rule is for inclusion of items with a value from X to Z, then the rule may be adjusted so that the range is from Y to Z to not incorporate the item deselected by the user. When another item is not selected or deselected, the method 300 may proceed to block 316.

In block 316, it may be determined if an action is selected. An action may be an operation that may be performed on the items in the item selection set. When an action is selected, the method 300 may proceed to block 318. When an action is not selected, the method 300 may proceed to block 314. In block 318, the item selection set may be presented in a second window separate from unselected items.

In block 320, it may be determined if an item in the item selection set presented in the second window is deselected. When an item is deselected, the method 300 may proceed to block 322. When an item is not deselected, the method 300 may proceed to block 324.

In block 322, the item that is deselected may be removed from the item selection set. In these and other embodiments, the deselected item may not be presented in the second window but may be presented with other items in the user interface that are not part of the item selection set.

In block 324, it may be determined if the action is confirmed. When the action is confirmed, the method 300 may proceed to block 326. When the action is not confirmed, the method 300 may proceed to block 320. In block 326, the action may be performed on the items in the item selection set.

One skilled in the art will appreciate that, for this and other processes and methods disclosed herein, the functions and/or operations performed in the processes and methods may be implemented in differing order. Furthermore, the outlined functions and operations are only provided as examples, and some of the functions and operations may be optional, combined into fewer functions and operations, or expanded into additional functions and operations without detracting from the essence of the disclosed embodiments.

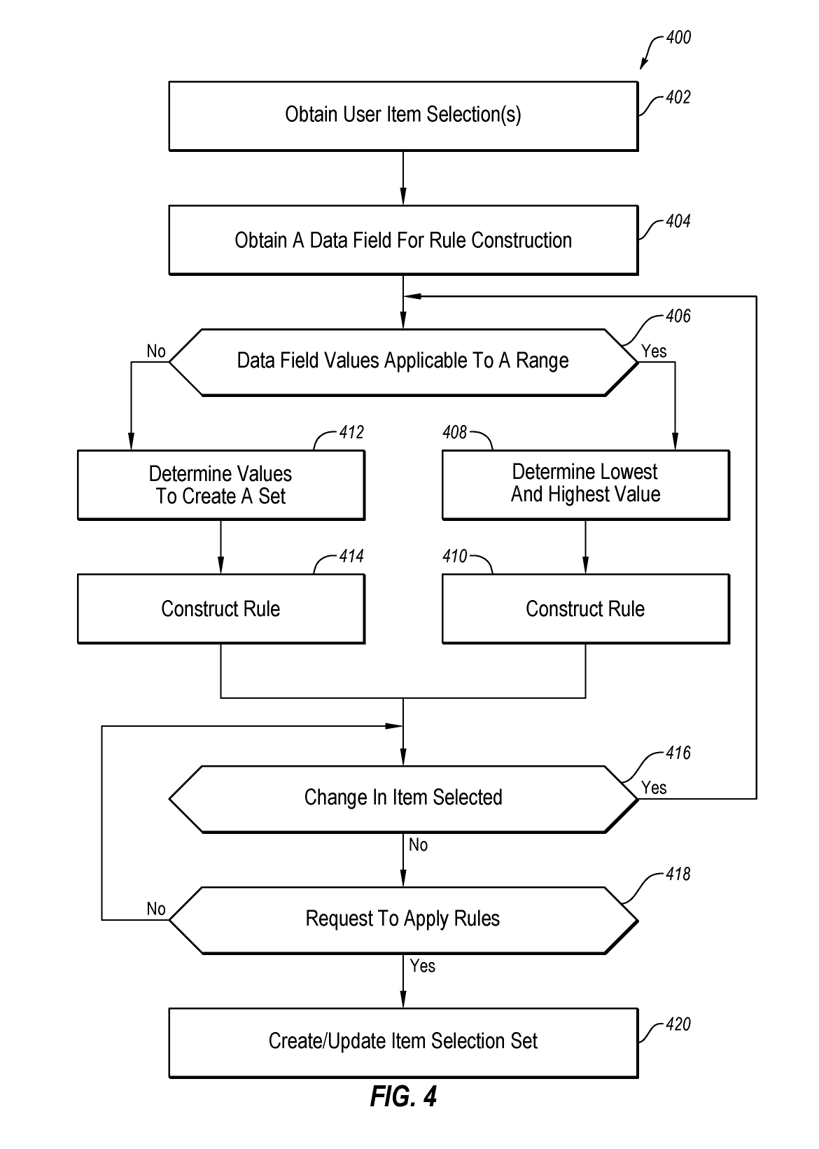

FIG. 4 is a flowchart of an example computer-implemented method 400 of constructing rules. The method 400 may be arranged in accordance with at least one embodiment described in the present disclosure. The method 400 may be implemented, in some embodiments, by a system, such as the system 100 and/or 700 of FIGS. 1 and 7, respectively. Although illustrated as discrete blocks, various blocks may be divided into additional blocks, combined into fewer blocks, or eliminated, depending on the desired implementation.

The method 400 may begin at block 402, where a user selection of items may be obtained. In these and other embodiments, the items may be presented in a user interface. The items may include multiple data fields with data values.

In block 404, a data field from the items may be obtained for rule construction. The data field may be used for construction of a rule to apply to the items to automatically create an item selection set. The data field may be obtained based on instructions received over a network. Alternatively or additionally, the data field for rule construction may be obtained based on a user selection.

In block 406, it may be determined if values in the data field are applicable to a range. In these and other embodiments, the type of the values in the data field may be used to determine if the values are applicable to a range. For example, if the values are dates, sizes, prices, or other numerical values, then the values may be applicable to a range. If the values are categories or text, then the values may not be applicable to a range. In some embodiments, information regarding the applicability of values in a data field to a range may be obtained. The determination may be based on the obtained information. For example, instructions regarding presenting the user interface may include an indication if values in a data field are applicable to a range. When the values are applicable to a range, the method 400 may proceed to block 408. When the values are not applicable to a range, the method 400 may proceed to block 412.

In block 408, the lowest value and the highest value from the selected items may be determined. In some embodiments, the values may be sorted to determine the highest and lowest values. Alternatively or additionally, other methods may be applied to determine the highest and lowest values. In some embodiments, additional information about the values from the selected items may be determined. For example, a medium, mean, and clustering of the values may be determined.

In block 410, a rule may be constructed using the lowest and highest values. In these and other embodiments, when values are clustered between the lowest and highest values the rule may be to select items with values between the highest and lowest values. Alternatively or additionally, when the values are clustered near the lowest and highest values, such as having a standard deviation between the values in the clusters, the rule may be to select items that are between 0 and the lowest value and higher than the highest value. Alternatively or additionally, based on the clustering, a rule may include multiple ranges that include boundaries that are not zero or infinity.

In block 412, each of the unique values from the selected items may be identified to create a set of values. For example, each of the values from the selected items may be compared to a set of the items. If a value is not in the set, the value may be added to the set. If the value is in the set, the value may not be added to the set.

In block 414, a rule may be constructed using the set of values. In these and other embodiments, the rule may be to select items with values that match the values in the set.

In block 416, it may be determined if there is a change in the items selected. When there is a change, the method 400 may proceed to block 406. The change may result in a change in the rule determined in block 410 or block 414 by changing the data values of selected items used to construct the rule. When there is not a change, the method 400 may proceed to block 418.

In block 418, it may be determined if a request has been obtained to apply the rules to the items. When there has not been a request, the method 400 may proceed to block 416. When there has been a request, the method 400 may proceed to block 420.

In block 420, an item selection set may be created based on the rule. In these and other embodiments, the items selection set may be created from items that adhere to the rule. Alternatively or additionally, an item selection set may be updated based on the rule. For example, in some embodiments, an item selection may exist based on previous rules. Based on changes to items in the item selection set from the user, one or more of the rules may be updated and/or changed. The updated and/or changed rules may be applied to the item selection set to update the item selection set.

One skilled in the art will appreciate that, for this and other processes and methods disclosed herein, the functions and/or operations performed in the processes and methods may be implemented in differing order. Furthermore, the outlined functions and operations are only provided as examples, and some of the functions and operations may be optional, combined into fewer functions and operations, or expanded into additional functions and operations without detracting from the essence of the disclosed embodiments.

For instance, in some embodiments, the method 400 may further include a loop to create additional rules for each of the data fields that are indicated for rule construction. In these and other embodiments, an item may be selected for the item selection set when the item adheres to all of the rules. Alternatively or additionally, an item may be selected for the item selection set when the item adheres to one or more of the rules.

In some embodiments, the method 400 may be combined with the method 300. For example, the blocks 402, 404, 406, 408, 410, 412, 414, 416, 418, and 420 of method 400 may replace the blocks 302, 304, 306, 308, 310, and 312 of method 300. Alternatively or additionally, the blocks 404, 406, 408, 410, 412, 414, 416 of method 400 may replace the blocks 302, 304, and 306 of method 300. Other combinations or substitutions among the blocks of method 300 and of method 400 may also be used to create an item selection set.

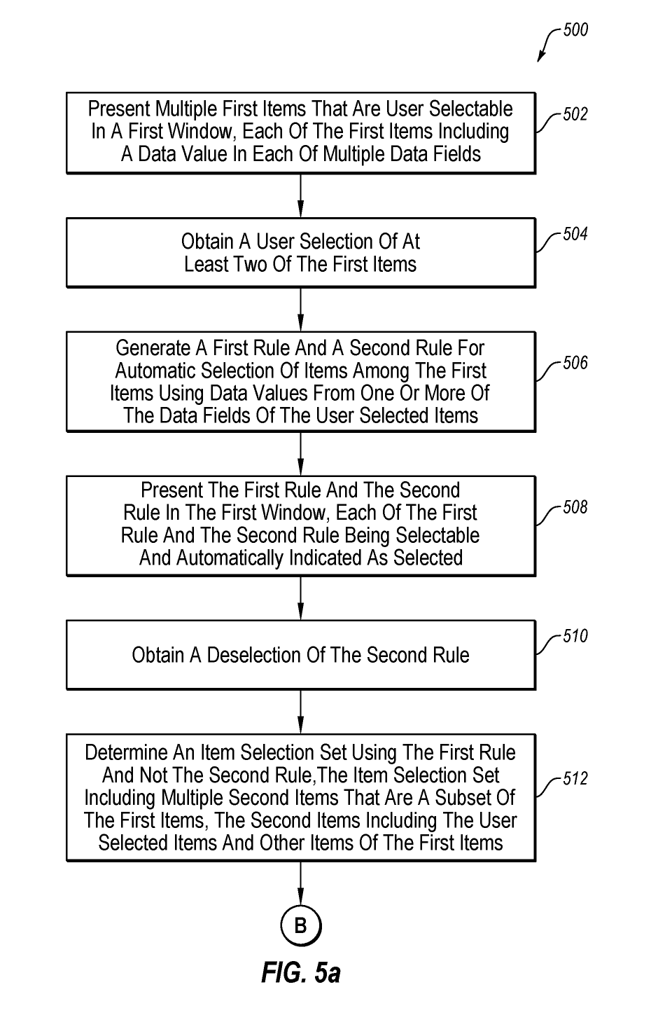

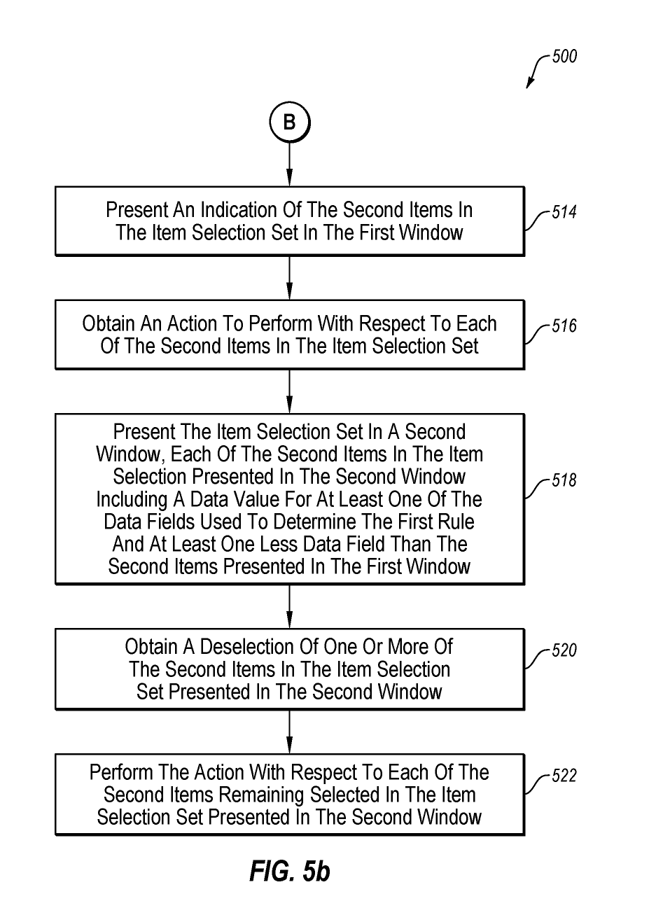

FIGS. 5a and 5b are a flowchart of operations 500 to perform actions on an item selection set. The operations 500 may be arranged in accordance with at least one embodiment described in the present disclosure. The operations 500 may be implemented, in some embodiments, by a system, such as the system 100 and/or 700 of FIGS. 1 and 7, respectively. Although illustrated as discrete blocks, various blocks may be divided into additional blocks, combined into fewer blocks, or eliminated, depending on the desired implementation.

The operations 500 may begin at block 502, where multiple first items that are user selectable may be presented in a first window. In some embodiments, each of the first items may include a data value in each of multiple data fields in the items. In block 504, a user selection of at least two of the first items may be obtained.

In block 506, a first rule and a second rule for automatic selection of items among the first items may be generated using data values from one or more of the data fields of the user selected items.

In block 508, the first rule and the second rule may be presented in the first window. In some embodiments, each of the first rule and the second rule may be selectable and automatically indicated as selected. Alternatively or additionally, each of the first rule and the second rule may be editable.

In block 510, a deselection of the second rule may be obtained. In block 512, an item selection set may be determined using the first rule and not the second rule. In some embodiments, the item selection set may include multiple second items that are a subset of the first items. The second items may include the user selected items and other items of the first items.

In block 514, an indication of the second items in the item selection set may be presented in the first window. In block 516, an action to perform with respect to each of the second items in the item selection set may be obtained.

In block 518, the item selection set may be presented in a second window. In these and other embodiments, each of the second items in the item selection presented in the second window may include a data value for at least one of the data fields used to determine the first rule and at least one less data field than the second items presented in the first window. In some embodiments, one of the at least one less data field may include a third data field used to determine the second rule.

In block 520, a deselection of one or more of the second items in the item selection set that is presented in the second window may be obtained.

In block 522, the action may be performed with respect to each of the second items remaining selected in the item selection set presented in the second window.

One skilled in the art will appreciate that, for this and other processes, methods, and operations disclosed herein, the functions performed in the processes, methods, and operations may be implemented in differing order. Furthermore, the outlined functions and operations are only provided as examples, and some of the functions and operations may be optional, combined into fewer functions and operations, or expanded into additional functions and operations without detracting from the essence of the disclosed embodiments.

For example, in some embodiments, the operations 500 may further include obtaining an edit of the first rule that adjusts a condition of the first rule. In these and other embodiments, the item selection set may be determined using the first rule incorporating the edit.

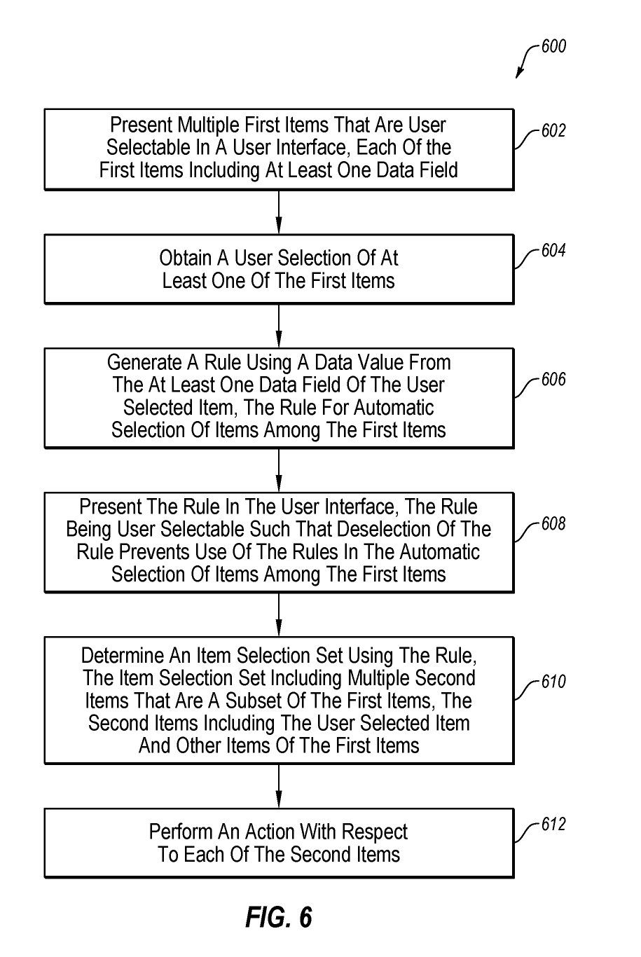

FIG. 6 is a flowchart of an example computer-implemented method 600 of item selection. The method 600 may be arranged in accordance with at least one embodiment described in the present disclosure. The method 600 may be implemented, in some embodiments, by a system, such as the system 100 and/or 700 of FIGS. 1 and 7, respectively. Although illustrated as discrete blocks, various blocks may be divided into additional blocks, combined into fewer blocks, or eliminated, depending on the desired implementation.

The method 600 may begin at block 602, where multiple first items that are user selectable in a user interface may be presented. In some embodiments, each of the first items may include at least one data field. In block 604, a user selection of at least one of the first items may be obtained.

In block 606, a rule may be generated using a data value from the at least one data field of the user selected item. In some embodiments, the rule may be for automatic selection of items among the first items. In some embodiments, the rule may be editable and selectable. In these and other embodiments, the method 600 may further include obtaining an edit of the rule that adjusts a condition of the rule.

In block 608, the rule may be presented in the user interface. In some embodiments, the rule may be user selectable such that deselection of the rule prevents use of the rules in the automatic selection of items from the first items.

In block 610, an item selection set may be determined using the rule. In some embodiments, the item selection set may include multiple second items that are a subset of the first items. In these and other embodiments, the second items may include the user selected item and other items of the first items. In some embodiments, the item selection set may be determined using the rule that incorporates an edit of the rule. In block 612, an action may be performed with respect to each of the second items.

One skilled in the art will appreciate that, for this and other processes and methods disclosed herein, the functions and/or operations performed in the processes and methods may be implemented in differing order. Furthermore, the outlined functions and operations are only provided as examples, and some of the functions and operations may be optional, combined into fewer functions and operations, or expanded into additional functions and operations without detracting from the essence of the disclosed embodiments.

For instance, in some embodiments, the method 600 may further include, obtaining a user selection of a subset of the first items. In these and other embodiments, the subset may include multiples of the first items. The method 600 may further include generating multiple rules for automatic selection of items among the first items using data values from the subset of the first items and presenting the rules in the user interface. In these and other embodiments, each of the rules may be selectable and automatically indicated as selected.

In some embodiments, the method 600 may further include presenting an indication of the second items in the item selection set in a first window of the user interface. Alternatively or additionally, the method 600 may further include presenting an indication of the second items in the item selection set in a first window of the user interface. In these and other embodiments, the method 600 may further include obtaining an action to perform with respect to each of the second items in the item selection set and presenting the item selection set in a second window in the user interface. In these and other embodiments, each of the second items in the item selection set presented in the second window may include a data value for at least one of the data fields used to determine the rule and at least one less data field than the second items presented in the first window. In these and other embodiments, the method 600 may further include obtaining a deselection of one or more of the second items in the item selection set presented in the second window and performing the action with respect to each of the second items remaining selected in the item selection set presented in the second window.

FIG. 7 illustrates another example system 700 configured to present a digital user interface. The system 700 may be arranged in accordance with at least one embodiment described in the present disclosure. The system 700 may include a processor 710, a memory 712, a database 714, a communication unit 720, and a user interface unit 730, which all may be communicatively coupled. In some embodiments, the system 700 may be part of any of the systems or devices described in this disclosure. For example, the system 700 may be part of the information system 112, the computing system 120, and/or the device 140 of FIG. 1.

In some embodiments, the system 700 may be part of an on-line marketplace. The online marketplace may be any configuration of hardware, such as servers and databases, which are configured to provide an on-line marketplace for a seller or sellers to sell goods to buyers. For example, the on-line marketplace may be configured to provide a number of publishing, listing, and price-setting mechanisms whereby a seller may list (or publish information concerning) goods or services for sale, a buyer can express interest in or indicate a desire to purchase such goods or services, and a price can be set for a transaction pertaining to the goods or services. The prices set for a transaction may be auction-format listing and price setting mechanisms (e.g., English, Dutch, Chinese, Double, Reverse auctions, etc.). Other types of price listing formats may also be used. For example, a fixed-price listing format (e.g., the traditional classified advertisement-type listing or a catalogue listing) or a buyout-type listing format may be used. In these and other embodiments, a buyout-type listing may be offered in conjunction with auction-format listings and allow a buyer to purchase goods or services, which are also being offered for sale via an auction, for a fixed price that is typically higher than a starting price of an auction for an item.

In these and other embodiments, the system 700 may be configured to provide instructions and items to a device. The instructions may allow the device to generate a user interface that may be used to present the items and to provide actions to be performed on the items back to the system 700.

Generally, the processor 710 may include any suitable special-purpose or general-purpose computer, computing entity, or processing device including various computer hardware or software modules and may be configured to execute instructions stored on any applicable computer-readable storage media. For example, the processor 710 may include a microprocessor, a microcontroller, a digital signal processor (DSP), an application-specific integrated circuit (ASIC), a Field-Programmable Gate Array (FPGA), or any other digital or analog circuitry configured to interpret and/or to execute program instructions and/or to process data.

Although illustrated as a single processor in FIG. 7, it is understood that the processor 710 may include any number of processors distributed across any number of network or physical locations that are configured to perform individually or collectively any number of operations described herein. In some embodiments, the processor 710 may interpret and/or execute program instructions and/or process data stored in the memory 712, the database 714, or the memory 712 and the database 714. In some embodiments, the processor 710 may fetch program instructions from the database 714 and load the program instructions into the memory 712.

After the program instructions are loaded into the memory 712, the processor 710 may execute the program instructions. For example, the system 700 may be part of the computing system 120 of FIG. 1. In these and other embodiments, the instructions may include the processor 710 instructing the communication unit 720 to send instructions and items to the device 140.

As another example, the system 700 may be part of the device 140 of FIG. 1. For example, in these and other embodiments, the instructions may include the processor 710 receiving user input from the user interface unit 730 regarding selection of items or rules.

The memory 712 and the database 714 may include computer-readable storage media or one or more computer-readable storage mediums for carrying or having computer-executable instructions or data structures stored thereon. Such computer-readable storage media may be any available media that may be accessed by a general-purpose or special-purpose computer, such as the processor 710. By way of example, and not limitation, such computer-readable storage media may include non-transitory computer-readable storage media including Random Access Memory (RAM), Read-Only Memory (ROM), Electrically Erasable Programmable Read-Only Memory (EEPROM), Compact Disc Read-Only Memory (CD-ROM) or other optical disk storage, magnetic disk storage or other magnetic storage devices, flash memory devices (e.g., solid state memory devices), or any other storage medium which may be used to carry or store desired program code in the form of computer-executable instructions or data structures and which may be accessed by a general-purpose or special-purpose computer. Combinations of the above may also be included within the scope of computer-readable storage media. In these and other embodiments, the term “non-transitory” as used herein should be construed to exclude only those types of transitory media that were found to fall outside the scope of patentable subject matter in the Federal Circuit decision of In re Nuijten, 500 F.3d 1346 (Fed. Cir. 2007). In some embodiments, computer-executable instructions may include, for example, instructions and data configured to cause the processor 710 to perform a certain operation or group of operations, such as one or more blocks of the operations 500 or one or more blocks of the methods 300, 400, and/or 600.

The communication unit 720 may include any component, device, system, or combination thereof that is configured to transmit or receive information over a network. In some embodiments, the communication unit 720 may communicate with other devices at other locations, the same location, or even other components within the same system. For example, the communication unit 720 may include a modem, a network card (wireless or wired), an infrared communication device, a wireless communication device (such as an antenna), and/or chipset (such as a Bluetooth device, an 802.6 device (e.g., Metropolitan Area Network (MAN)), a WiFi device, a WiMax device, cellular communication facilities, etc.), and/or the like. The communication unit 720 may permit data to be exchanged with a network and/or any other devices or systems described in the present disclosure. For example, if the communication unit 720 is included in the computing system 120 of FIG. 1, the communication unit 720 may be configured to communicate with the database 130 and/or the device 140 over the network 110 of FIG. 1.

The user interface unit 730 may include any device to allow a user to interface with the system 700. For example, the user interface unit 730 may include a mouse, a track pad, a keyboard, a touchscreen, among other devices. The user interface unit 730 may receive input from a user and provide the input to the processor 710. Modifications, additions, or omissions may be made to the system 700 without departing from the scope of the present disclosure.

As indicated above, the embodiments described herein may include the use of a special purpose or general purpose computer (e.g., the processor 710 of FIG. 7) including various computer hardware or software modules, as discussed in greater detail below. Further, as indicated above, embodiments described herein may be implemented using computer-readable media (e.g., the memory 712 or database 714 of FIG. 7) for carrying or having computer-executable instructions or data structures stored thereon.

In some embodiments, the different components, modules, engines, and services described herein may be implemented as objects or processes that execute on a computing system (e.g., as separate threads). While some of the systems and methods described herein are generally described as being implemented in software (stored on and/or executed by general purpose hardware), specific hardware implementations or a combination of software and specific hardware implementations are also possible and contemplated.

In accordance with common practice, the various features illustrated in the drawings may not be drawn to scale. The illustrations presented in the present disclosure are not meant to be actual views of any particular apparatus (e.g., device, system, etc.) or method, but are merely idealized representations that are employed to describe various embodiments of the disclosure. Accordingly, the dimensions of the various features may be arbitrarily expanded or reduced for clarity. In addition, some of the drawings may be simplified for clarity. Thus, the drawings may not depict all of the components of a given apparatus (e.g., device) or all operations of a particular method.

In some embodiments, the different components, modules, engines, and services described herein may be implemented as objects or processes that execute on a computing system (e.g., as separate threads). While some of the systems and methods described herein are generally described as being implemented in software (stored on and/or executed by general purpose hardware), specific hardware implementations or a combination of software and specific hardware implementations are also possible and contemplated.

Terms used herein and especially in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc. For example, the use of the term “and/or” is intended to be construed in this manner.

Further, any disjunctive word or phrase presenting two or more alternative terms, whether in the description, claims, or drawings, should be understood to contemplate the possibilities of including one of the terms, either of the terms, or both terms. For example, the phrase “A or B” should be understood to include the possibilities of “A” or “B” or “A and B.”

However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

Additionally, the use of the terms “first,” “second,” “third,” etc., are not necessarily used herein to connote a specific order or number of elements. Generally, the terms “first,” “second,” “third,” etc., are used to distinguish between different elements as generic identifiers. Absence a showing that the terms “first,” “second,” “third,” etc., connote a specific order, these terms should not be understood to connote a specific order. Furthermore, absence a showing that the terms “first,” “second,” “third,” etc., connote a specific number of elements, these terms should not be understood to connote a specific number of elements. For example, a first widget may be described as having a first side and a second widget may be described as having a second side. The use of the term “second side” with respect to the second widget may be to distinguish such side of the second widget from the “first side” of the first widget and not to connote that the second widget has two sides.

All examples and conditional language recited herein are intended for pedagogical objects to aid the reader in understanding the invention and the concepts contributed by the inventor to furthering the art, and are to be construed as being without limitation to such specifically recited examples and conditions. Although embodiments of the present disclosure have been described in detail, it should be understood that the various changes, substitutions, and alterations could be made hereto without departing from the spirit and scope of the present disclosure.

What is claimed is:

1. One or more non-transitory computer-readable media configured to store instructions that when executed by one or more processing systems performs operations of performing actions on an item selection set in a user interface, the operations comprising:
presenting a first plurality of items that are user selectable in a first window, each of the first plurality of items including a data value in each of a plurality of data fields;
obtaining a user selection of at least two of the first plurality of items;
generating a first rule and a second rule for automatic selection of items among the first plurality of items using data values from one or more of the plurality of data fields of the user selected items;
presenting the first rule and the second rule in the first window, each of the first rule and the second rule being selectable and automatically indicated as selected;
obtaining a deselection of the second rule;
determining an item selection set using the first rule and not the second rule, the item selection set including a second plurality of items that are a subset of the first plurality of items, the second plurality of items including the user selected items and other items of the first plurality of items;
presenting an indication of the second plurality of items in the item selection set in the first window;
obtaining an action to perform with respect to each of the second plurality of items in the item selection set;
presenting the item selection set in a second window, each of the second plurality of items in the item selection set presented in the second window including a data value for at least one of the data fields used to determine the first rule and at least one less data field than the second plurality of items presented in the first window;
obtaining a deselection of one or more of the second plurality of items in the item selection set presented in the second window; and
performing the action with respect to each of the second plurality of items remaining selected in the item selection set presented in the second window.

2. The one or more non-transitory computer-readable media of claim 1, wherein one of the at least one less data field includes a third data field used to determine the second rule.

3. The one or more non-transitory computer-readable media of claim 1, wherein each of the first rule and the second rule are editable.

4. The one or more non-transitory computer-readable media of claim 3, wherein the operations further comprise obtaining an edit of the first rule that adjusts a condition of the first rule, wherein the item selection set is determined using the first rule incorporating the edit.

5. One or more non-transitory computer-readable media configured to store instructions that when executed by one or more processing systems performs operations of item selection, the operations comprising:
presenting a first plurality of items that are user selectable in a user interface, each of the first plurality of items including at least one data field;
obtaining a user selection of at least one of the first plurality of items;
generating a rule using a data value from the at least one data field of the user selected item, the rule for automatic selection of items among the first plurality of items;
presenting the rule in the user interface, the rule being user selectable such that deselection of the rule prevents use of the rules in the automatic selection of items among the first plurality of items;
determining an item selection set using the rule, the item selection set including a second plurality of items that are a subset of the first plurality of items, the second plurality of items including the user selected item and other items of the first plurality of items; and
performing an action with respect to each of the second plurality of items.

6. The one or more non-transitory computer-readable media of claim 5, wherein the operations further comprise:
obtaining a user selection of a subset of the first plurality of items, the subset including a plurality of the first plurality of items;
generating a plurality of rules for automatic selection of items among the first plurality of items using data values from the subset of the first plurality of items; and
presenting the plurality of rules in the user interface, each of the plurality of rules being selectable and automatically indicated as selected.

7. The one or more non-transitory computer-readable media of claim 5, wherein the operations further comprise presenting the item selection set in a second window in the user interface, each of the second plurality of items in the item selection set presented in the second window including a data value for at least one of the data fields used to determine the rule.

8. The one or more non-transitory computer-readable media of claim 5, wherein the operations further comprise presenting an indication of the second plurality of items in the item selection set in a first window of the user interface.

9. The one or more non-transitory computer-readable media of claim 8, wherein the operations further comprise:
obtaining an action to perform with respect to each of the second plurality of items in the item selection set; and
presenting the item selection set in a second window in the user interface, each of the second plurality of items in the item selection set presented in the second window including a data value for at least one of the data fields used to determine the rule and at least one less data field than the second plurality of items presented in the first window.

10. The one or more non-transitory computer-readable media of claim 9, wherein the operations further comprise:
obtaining a deselection of one or more of the second plurality of items in the item selection set presented in the second window; and
performing the action with respect to each of the second plurality of items remaining selected in the item selection set presented in the second window.

11. The one or more non-transitory computer-readable media of claim 5, wherein the rule is editable and selectable.

12. The one or more non-transitory computer-readable media of claim 11, wherein the operations further comprise obtaining an edit of the rule that adjusts a condition of the rule, wherein the item selection set is determined using the rule incorporating the edit.

13. A computer-implemented method of item selection, the method comprising:
presenting a first plurality of items that are user selectable in a user interface, each of the first plurality of items including at least one data field;
obtaining a user selection of at least one of the first plurality of items;
generating a rule using a data value from the at least one data field of the user selected item, the rule for automatic selection of items among the first plurality of items;
presenting the rule in the user interface, the rule being user selectable such that deselection of the rule prevents use of the rules in the automatic selection of items among the first plurality of items;
determining an item selection set using the rule, the item selection set including a second plurality of items that are a subset of the first plurality of items, the second plurality of items including the user selected item and other items of the first plurality of items; and
performing an action with respect to each of the second plurality of items.

14. The computer-implemented method of claim 13, further comprising:
obtaining a user selection of a subset of the first plurality of items, the subset including a plurality of the first plurality of items;
generating a plurality of rules for automatic selection of items among the first plurality of items using data values from the subset of the first plurality of items; and
presenting the plurality of rules in the user interface, each of the plurality of rules being selectable and automatically indicated as selected.

15. The computer-implemented method of claim 13, further comprising presenting the item selection set in a second window in the user interface, each of the second plurality of items in the item selection set presented in the second window including a data value for at least one of the data fields used to determine the rule.

16. The computer-implemented method of claim 13, further comprising presenting an indication of the second plurality of items in the item selection set in a first window of the user interface.

17. The computer-implemented method of claim 16, further comprising:
obtaining an action to perform with respect to each of the second plurality of items in the item selection set; and
presenting the item selection set in a second window in the user interface, each of the second plurality of items in the item selection presented in the second window including a data value for at least one of the data fields used to determine the rule and at least one less data field than the second plurality of items presented in the first window.

18. The computer-implemented method of claim 17, further comprising:
obtaining a deselection of one or more of the second plurality of items in the item selection set presented in the second window; and
performing the action with respect to each of the second plurality of items remaining selected in the item selection set presented in the second window.

19. The computer-implemented method of claim 13, wherein the rule is editable and selectable.

20. The computer-implemented method of claim 19, further comprising obtaining an edit of the rule that adjusts a condition of the rule, wherein the item selection set is determined using the rule incorporating the edit.
